(19) United States
(12) Patent Application Publication
(10) Pub. No.: US 2014/0149194 A1
(43) Pub. Date: May 29, 2014

(54) GRANTING OF BENEFITS

(71) Applicant: NEC BIGLOBE, LTD., Tokyo (JP)

(72) Inventor: Kouji SUGANUMA, Tokyo (JP)

(73) Assignee: NEC BIGLOBE, LTD., Tokyo (JP)

(21) Appl. No.: 14/085,481

(22) Filed: Nov. 20, 2013

(30) Foreign Application Priority Data
Nov. 26, 2012 (JP) 2012-257253

(51) Int. Cl. G06Q 30/02

(52) U.S. Cl. CPC G06Q 30/0214
USPC 705/14.16

(57) ABSTRACT

A communication terminal uses an application to request that an administrative server provide an invitation code. The administrative server generates and transmits an invitation code that is unique to the communication terminal and that can be used for a plurality of applications used for invitation code requests. The communication terminal discloses the invitation code that was transmitted, and also discloses application information, and when other communication terminals use the application to designate the invitation code, the administrative server grants benefits to the communication terminal according to an invitation number that is the number of communication terminals that have designated the invitation code.

### GRANTING OF BENEFITS

This application is based upon and claims the benefit of priority from Japanese Patent Application No. 2012-257253 filed on Nov. 26, 2012, the content of which is incorporated by reference.

### TECHNICAL FIELD

The present invention relates to an administrative system, an administrative server, an administration method, and a program for administering benefit codes.

### BACKGROUND ART

In recent years, a technology has been conceived by which an invitation code for the exclusive use of an application that operates on a smartphone is issued in the application, and the invitation code is then used to promote the use (purchase) of the application (for example, see Patent Document 1).

A user to whom an invitation code has been issued, when using a communication terminal to offer information of the application (introduce the application) on, for example, social media such as a blog, mini-bulletin board, or SNS (Social Networking Service) that accumulates information or transmits and receives information among a plurality of communication terminals, presents the invitation code that was issued. Another user that views this information of the application then newly downloads the application to his or her own communication terminal and enters the invitation code in the application that was downloaded, whereupon the user who was issued the invitation code and the user who entered the invitation code are granted benefits (for example, items that can be used in the application). The use and purchase of the application is thus promoted.

### CITATION LIST

### Patent Literature

Patent Literature 1: Japanese Unexamined Patent Application Publication No. 2002-143567

### SUMMARY OF THE INVENTION

### Technical Problem

Nevertheless, the invitation code that is used in the above-described technology is issued for each application only for the exclusive use of that application. As a result, the benefits that are granted will be the same whether the user introduces the application offered by the business that offers the application (hereinbelow referred to as the application business) for the first time or is a user who has introduced a multiple number of applications that are offered by this application business. The problem therefore arises that a user is given no motivation to introduce other applications of the application business.

It is an object of the present invention to provide an administrative system, an administrative server, an administration method, and a program that provide a solution to the above-described problem.

### Solution to the Problem

The administrative system of the present invention is an administrative system having a communication terminal and an administrative server; wherein:

the communication terminal uses an application to request that the administrative server provide an invitation code, and discloses the invitation code that is transmitted in response to the request and also discloses application information for using the application;

the administrative server, when requested for the invitation code, generates an invitation code that is unique to the communication terminal and that can be used in common for a plurality of applications that are used in invitation code requests, transmits the invitation code that was generated to the communication terminal, and when another communication terminal uses the application to designate the invitation code that was disclosed, grants benefits according to an invitation number that is the number of communication terminals that have designated the invitation code to the communication terminal that disclosed the invitation code.

In addition, the administrative server of the present invention includes:

a code generation unit that, when a request is made from a communication terminal to provide an invitation code, generates an invitation code that is unique to the communication terminal and that can be used in common for a plurality of applications that are used in invitation code requests and transmits the generated invitation code to the communication terminal, and

a benefit granting unit that, when a communication terminal other than the communication terminal that is the transmission destination of the invitation code uses an application to designate the invitation code, grants to the communication terminal that is the transmission destination of the invitation code a benefit that accords with an invitation number that is the number of communication terminals that have designated the invitation code.

Still further, the administration method of the present invention includes processes of: when a communication terminal makes a request for an invitation code, generating an invitation code that is unique to the communication terminal and that can be used in common for a plurality of applications that are used in invitation code requests;

transmitting the invitation code that was generated to the communication terminal; and

when a communication terminal other than the communication terminal that is the transmission destination of the invitation code uses an application to designate the invitation code, granting to the communication terminal that is the transmission destination of the invitation code a benefit that accords with an invitation number that is the number of communication terminals that have designated the invitation code.

The program of the present invention is a program for causing a computer to execute procedures of:

when a communication terminal makes a request for an invitation code, generating an invitation code that is unique to the communication terminal and that can be used in common for a plurality of applications that are used in invitation code requests;

transmitting the invitation code that was generated to the communication terminal; and

when a communication terminal other than the communication terminal that is the transmission destination of the invitation code uses an application to designate the invitation code, granting to the communication terminal that is the transmission destination of the invitation code a benefit that accords with an invitation number that is the number of communication terminals that have designated the invitation code.

### Advantageous Effects of the Invention

As described hereinabove, the present invention is able to strengthen user motivation to introduce applications.

The above and other objects, features, and advantages of the present invention will become apparent from the following description with reference to the accompanying drawings which illustrate an example of the present invention.

### BRIEF DESCRIPTION OF THE DRAWINGS

FIG. 1 shows an exemplary embodiment of the administrative system of the present invention.

FIG. 2 shows an example of the internal configuration of the administrative server shown in FIG. 1.

FIG. 3 shows an example of the invitation code table that is stored in the database shown in FIG. 2.

FIG. 4 shows an example of a grade table that is stored in the database shown in FIG. 2.

FIG. 5 is a sequence chart for describing the processes when the communication terminal shown in FIG. 1 requests that the administrative server provide an invitation code.

FIG. 6 shows an example of the invitation code table of the database in which information is registered in Step 5.

FIG. 7 is a sequence chart for describing the process in which the communication terminal shown in FIG. 1 downloads an application “AAA” based on the information disclosed by another communication terminal.

FIG. 8 is a sequence chart for describing the benefit granting process when the communication terminal shown in FIG. 1 executes application “AAA” and receives input of the invitation code that was disclosed by another person in application “AAA.”

FIG. 9 is a flow chart for describing an example of the details of the process of granting points of Step 23.

FIG. 10 shows an example of the content of the invitation code table that is stored in database after the point-granting process of Step 23.

FIG. 11 is a sequence chart for describing the process when the communication terminal shown in FIG. 1 uses application “AAA” to request that the administrative server provide an invitation code.

FIG. 12 shows an example of the invitation code table of the database in which information was registered in Step 35.

FIG. 13 is a sequence chart for describing the process when the communication terminal shown in FIG. 1 uses application “BBB” to request that the administrative server provide an invitation code.

FIG. 14 shows an example of the invitation code table of the database in which information was registered in Step 44.

FIG. 15 is a sequence chart for describing the process of granting a benefit when the communication terminal shown in FIG. 1 executes application “AAA” and receives the input of an invitation code on application “AAA.”

FIG. 16 is a flow chart for describing an example of the details of the process of granting points of Step 53.

FIG. 17 shows an example of the content of the invitation code table that is stored in database 102 after the process of granting points of Step 53 is completed.

FIG. 18 is a sequence chart for describing the process of granting a benefit when the communication terminal shown in FIG. 1 executes application “BBB” and receives the input of the invitation code on application “BBB.”

FIG. 19 is a flow chart for describing an example of the details of the process of granting points of Step 63.

FIG. 20 shows an example of the content of the invitation code table that was stored in the database after the process of granting points of Step 63 is completed.

FIG. 21 is a sequence chart for describing the process when the type of communication terminal that is registered in the invitation code table is changed.

FIG. 22 is a flow chart for describing an example of the details of the process of the transfer code issuing process of Step 72.

FIG. 23 shows an example of the content of the invitation code table that is stored in the database after the process of issuing a transfer code of Step 72.

FIG. 24 is a flow chart for describing an example of the details of the process of the transfer code issuing process of Step 78.

FIG. 25 shows an example of the content of the invitation code table that is stored in the database after the transfer process of Step 78.

### EXEMPLARY EMBODIMENTS

Exemplary embodiments of the present invention are next described with reference to the accompanying drawings.

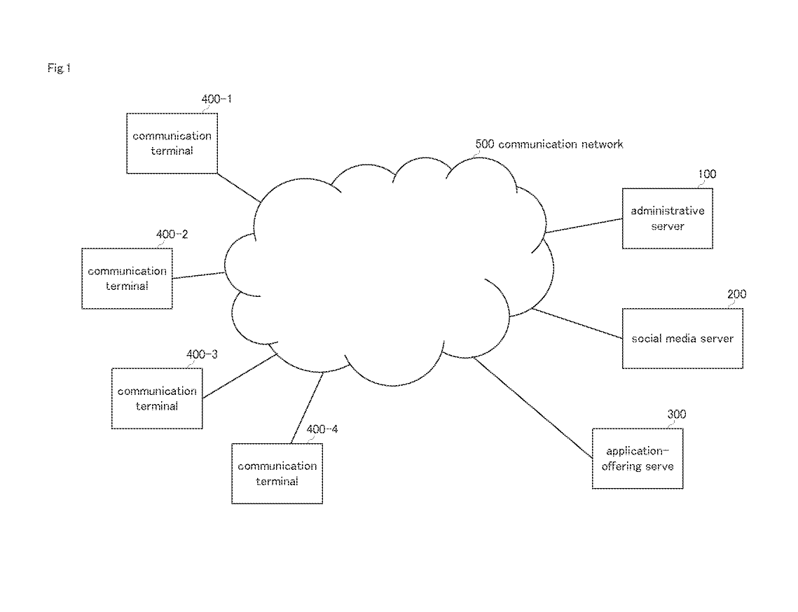

Referring to FIG. 1, an exemplary embodiment of the administrative system of the present invention is shown in which administrative server 100, social media server 200, application-offering server 300, and communication terminals 400-1-400-4 are connected by way of communication network 500. Although an example is shown in the embodiment shown in FIG. 1 in which there are four communication terminals, the present invention is not limited to this number.

Administrative server 100 is a server that administers benefits (points) that are granted to communication terminals 400-1-400-4.

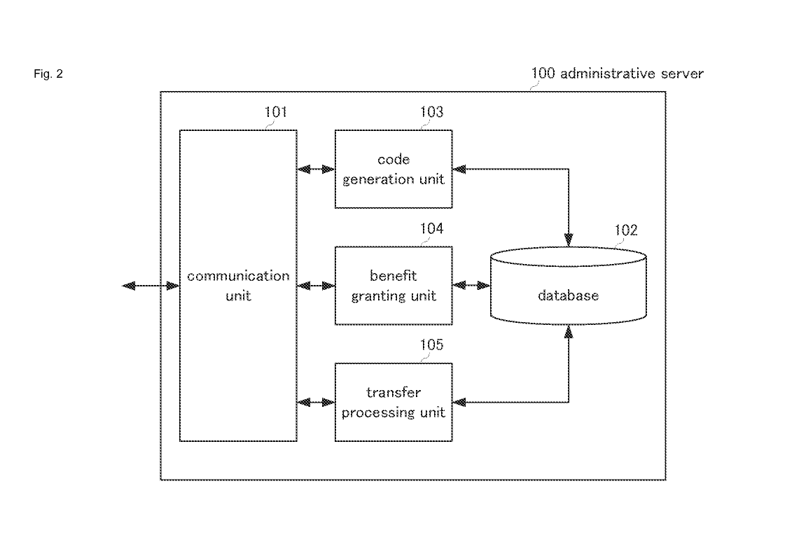

As shown in FIG. 2, administrative server 100 shown in FIG. 1 is provided with communication unit 101, database 102, code generation unit 103, benefit granting unit 104, and transfer processing unit 105.

Communication unit 101 carries out communication among communication terminals 400-1-400-4 by way of communication network 500.

Database 102 stores an invitation code table and a grade table. Database 102 may be a component that is provided outside administrative server 100 and that can be accessed from administrative server 100.

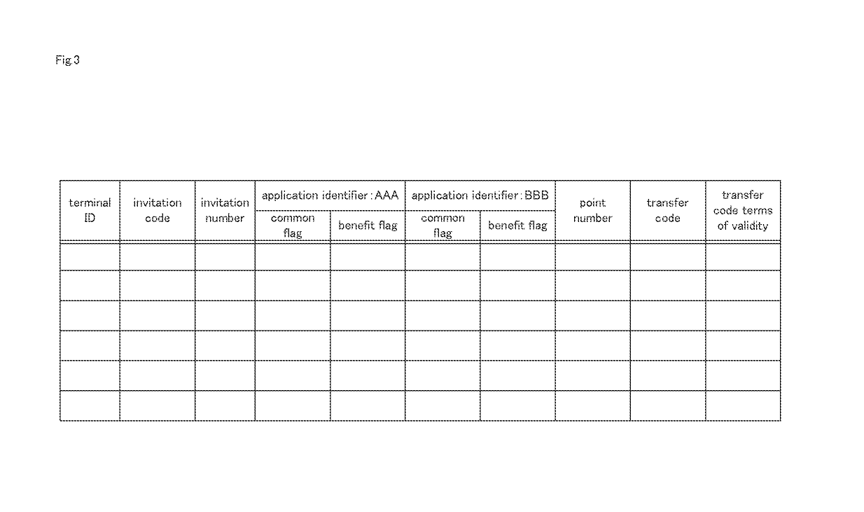

As shown in FIG. 3, the invitation code table that is stored in database 102 shown in FIG. 2 is composed of terminal IDs, invitation codes, invitation numbers, application identifiers, point numbers, transfer codes, and transfer code terms of validity that are placed in correspondence. Terminal IDs are terminal identification information that can distinguish communication terminals 400-1-400-4. For example, the terminal IDs may be the UIDs (User Identifiers), the MAC (Media Access Control) addresses, or the telephone numbers of communication terminals 400-1-400-4.

The invitation codes are code information that is generated by code generation unit 103 when generation is requested from communication terminals 400-1-400-4.

The invitation number is the number (cumulative number) of communication terminals that have used an application to designate (transmit) an invitation code that was generated.

The application identifier is identification information that can distinguish the applications (such as a number that can specify an application or the application name). The application identifiers that are stored here are the application identifiers of applications that can be offered for each application business. In this example, “AAA” and “BBB” are stored. In addition, common flags and benefit flags are stored for each application identifier. The common flags are raised (made active) for applications that are used in the generation requests when invitation codes are to be generated. For example, when the application for which the application identifier is AAA is used to request generation of an invitation code, the common flag of the application identifier “AAA” is raised when the invitation code is generated. In other words, the common flags are shared identification information that indicates that the generation of an invitation code has been requested through the use of the application of the application identifier. The benefit flags are raised (made active) for an application in correspondence with the terminal ID of a communication terminal when a benefit is granted to that application due to user's use of the application to designate (transmit) another person's invitation code (invitation code use) that is disclosed on, for example, social media server 200. In other words, benefit flags are designation identification information that indicates that an invitation code has been designated for the application of the application identifier. Alternatively, when a user, without relying on information such as an introduction by another person that is disclosed on social media server 200, installs an application and requests the issuance (generation) of an invitation code of his or her own communication terminal through that application, a flag may be raised showing that the benefit flag has become invalid for that application in association with the terminal ID of that communication terminal to indicate that the right to obtain a benefit by the invitation code of another person that is disclosed has become invalid.

The point numbers are the benefits that are granted for using an application to designate (transmit) a generated invitation code. This point number is successively added to and can be used, for example, to use or purchase applications or services or to acquire items. In addition, a communication terminal can use this point number in any application indicated by application identifiers for which common flags are raised. In FIG. 3, an example is shown in which the point number is taken as a benefit, but the benefit may also be images or items that can be used by the application, and in this case, the benefit may be identification information that can specify the images or items.

The transfer codes and transfer code terms of validity are used for transferring information that is stored in the invitation code table when there is a change in the apparatus types of communication terminals 400-1-400-4. Details regarding these points will be described hereinbelow.

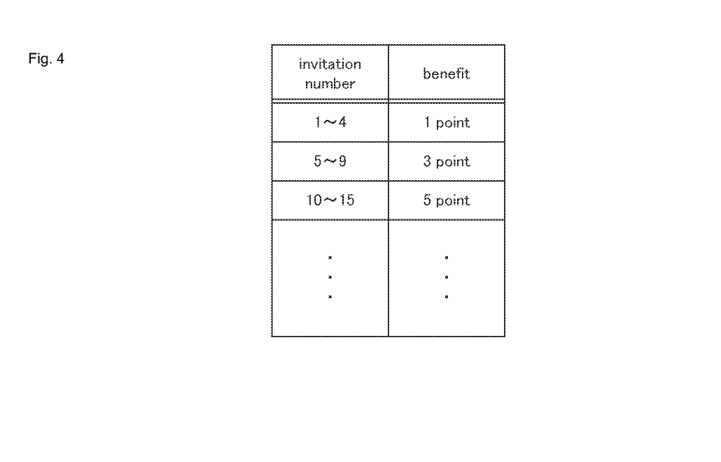

As shown in FIG. 4, the grade table that is stored in database 102 shown in FIG. 2 is composed of invitation numbers and benefits placed in correspondence.

The invitation number is the number of invitations stored in the invitation code table shown in FIG. 3.

The benefits are benefits granted for the number of points of the invitation code table shown in FIG. 3 (number of points in FIG. 4).

For example, when the invitation number is “1,” the number of points that are granted (added) is “1.” When the invitation number is “7,” the number of points that are granted (added) is “3.” When the invitation number is “12,” the number of points that are granted (added) is “5.” When the invitation number increases from “1” to “2,” the number of points that are granted is “1,” but when the invitation number increases from “5” to “6,” the number of points that are granted becomes “3.” Still further, when the invitation number increases from “10” to “11”, the number of points that are granted becomes “5.” In this way, the rate of increase of the number of points that are granted with respect to increase in the invitation number increases with an increase in the invitation number. In the example shown in FIG. 4, the rate of increase of the number of points that are granted increases in stages with respect to the increase of the invitation number, but the number of points may also increase in accordance with the function such as a linear function or a quadratic function.

The invitation code table and grade table may each be stored in separate databases. When invitation codes are requested from communication terminals 400-1-400-4, code generation unit 103 generates invitation codes. At this time, code generation unit 103 may use the terminal IDs that are transmitted from communication terminals 400-1-400-4 to generate invitation codes based on a predetermined rule (a rule that uses hashing or other information) or may generate invitation codes at random. Code generation unit 103 further transmits the generated invitation codes by way of communication unit 101 to communication terminals 400-1-400-4 that made the requests. These invitation codes can be used in common for a plurality of applications used in the invitation code requests.

When a communication terminal other than the communication terminal that was the transmission destination of an invitation code uses an application to designate an invitation code, benefit granting unit 104 grants a benefit to the communication terminal that is the transmission destination of the invitation code according to the invitation number, which is the number of communication terminals that have designated the invitation code. In addition, benefit-granting unit 104 stores the granted benefit in the invitation code table of database 102.

When a change occurs in the apparatus type of communication terminals 400-1-400-4, transfer processing unit 105 carries out a process for transferring the information that is stored in the invitation code table of database 102. Details of this process will be described hereinbelow.

The constituent elements shown in FIG. 2 may be provided dispersed among a plurality of devices.

Social media server 200 is a server that transmits and receives information and accumulates information among a plurality of communication terminals such as a blog, mini-bulletin board, or SNS.

Application-offering server 300 is a server that offers applications. For example, application-offering server 300 holds a plurality of applications that are offered from an application business (the use [acquisition] which may be charged or may be free of charge), and offers applications to communication terminals 400-1-400-4 through downloading by communication terminals 400-1-400-4.

Communication terminals 400-1-400-4 are communication devices such as smartphones that can download and use (execute) the applications. In addition, communication terminals 400-1-400-4 have control units, and the control units execute applications that are downloaded and request the administrative server to provide invitation codes. In addition, the control units of communication terminals 400-1-400-4 disclose the administrative codes and information for using applications that are transmitted in from administrative server 100. The display units (displays) provided in communication terminals 400-1-400-4 are used for this disclosure (display).

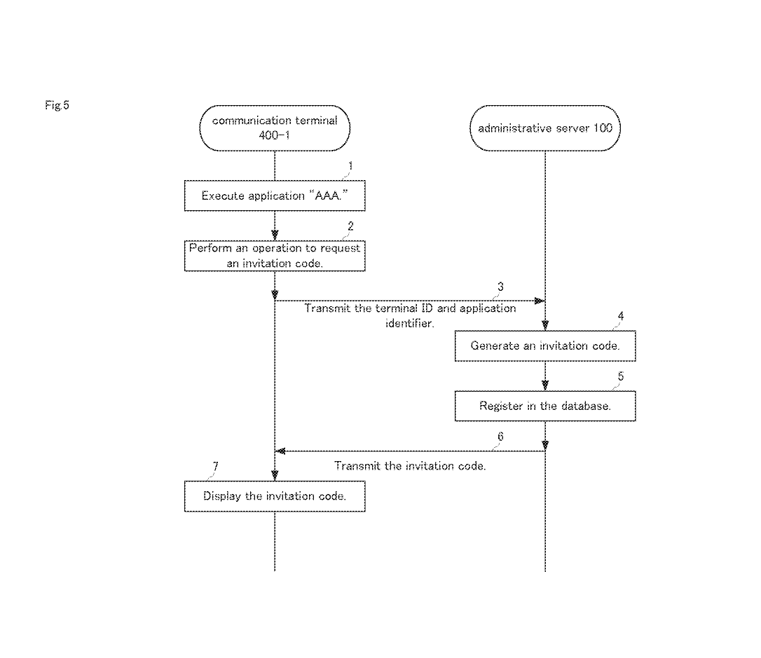

The administration method in the present exemplary embodiment is next described. The processing when communication terminal 400-1 requests an invitation code is first described with reference to FIG. 5. Here, communication terminal 400-1 is assumed to have downloaded application “AAA” from application-offering server 300. In addition, the terminal ID of communication terminal 400-1 is assumed to be “T000.”

In Step 1, communication terminal 400-1 executes application “AAA” that has been downloaded, and upon accepting an operation to request an invitation code in Step 2, communication terminal 400-1 transmits the terminal ID “T000” and application identifier “AAA” to administrative server 100 in Step 3. As the operation for requesting an invitation code, an operation is shown in which the user selects “issue invitation code” that is displayed on application “AAA.” When communication terminal 400-1 transmits the terminal ID “T000” and the application identifier “AAA,” these items are included in and transmitted with an invitation code request signal that indicates that an invitation code is being requested.

When the invitation code request signal that contains the terminal ID “T000” and the application identifier “AAA” is transmitted in from communication terminal 400-1, code generation unit 103 of administrative server 100 checks whether an invitation code for terminal ID “T000” has been registered in the invitation code table (whether application identifier “AAA” is stored such that it can issue (generate) an invitation code, or, when application identifier “AAA” is stored, whether or not a common flag for the application identifier “AAA” of terminal ID “T000” is “present”), and when an invitation code has not been registered for terminal ID “T000,” generates an invitation code based on a predetermined rule in Step 4. Code generation unit 103 then stores the generated invitation code in association with terminal ID “T000” in the invitation code table. Code generation unit 103 further raises the common flag of application identifier “AAA” that corresponds to terminal ID “T000” (sets the flag to “present”). At this time, code generation unit 103 may also raise a flag indicating that the benefit flag is invalid (set to “invalid”) when the benefit flag of the application identifier “AAA” that corresponds to terminal ID “T000” is “absent.” In this case, the benefit flag due to the use of another person's invitation code has not been raised, and the predetermined benefit for the use of an invitation code is therefore not granted. Code generation unit 103 further writes “0” to the invitation number corresponding to terminal ID “T000.” In addition, because an invitation code has not been generated for application “BBB,” code generation unit 103 does not raise the common flag or benefit flag of application identifier “BBB” (for example, writes “absent”). Still further, because a transfer code has still not yet been set, code generation unit 103 writes information indicating that settings have not been made in the transfer code corresponding to terminal ID “T000” (for example, writes “absent”). In this way, code generation unit 103 registers information relating to terminal ID “T000” in the invitation code table of database 102 in Step 5.

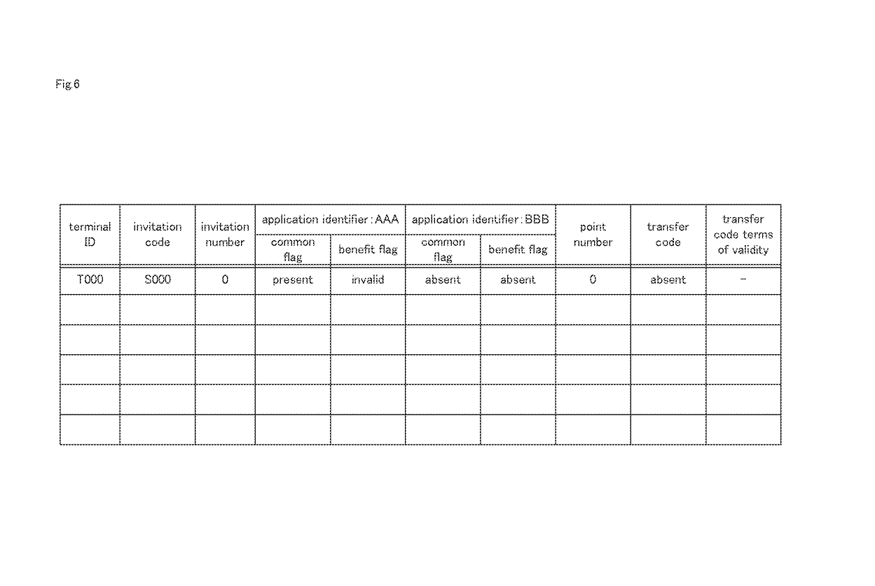

FIG. 6 shows an example of the invitation code table of database 102 in which information has been registered in Step 5. An example is here shown in which the invitation code generated by code generation unit 103 in Step 4 is “S000.”

As shown in FIG. 6, when the process of Step 5 is carried out, invitation code “S000,” invitation number “0,” the common flag “present” and the benefit flag “invalid” of application identifier: AAA, the common flag and benefit flag “absent” of application identifier: BBB, point number “0,” and transfer code “absent” are registered corresponding to terminal ID “T000” in the invitation code table. In addition, the transfer code term of validity is not registered because the transfer code is “absent.”

In Step 6, code generation unit 103 next transmits the generated invitation code to communication terminal 400-1 by way of communication unit 101, whereupon communication terminal 400-1 displays the invitation code that was transmitted in from administrative server 100 on application “AAA” in Step 7. This display may also be shown not on application “AAA” but on the display of communication terminal 400-1 as a typical notification. The user of communication terminal 400-1 discloses information such as this invitation code and the URL (Uniform Resource Locator) for acquiring application “AAA” in, for example, his or her own blog and thus promotes the use of application “AAA” to other users.

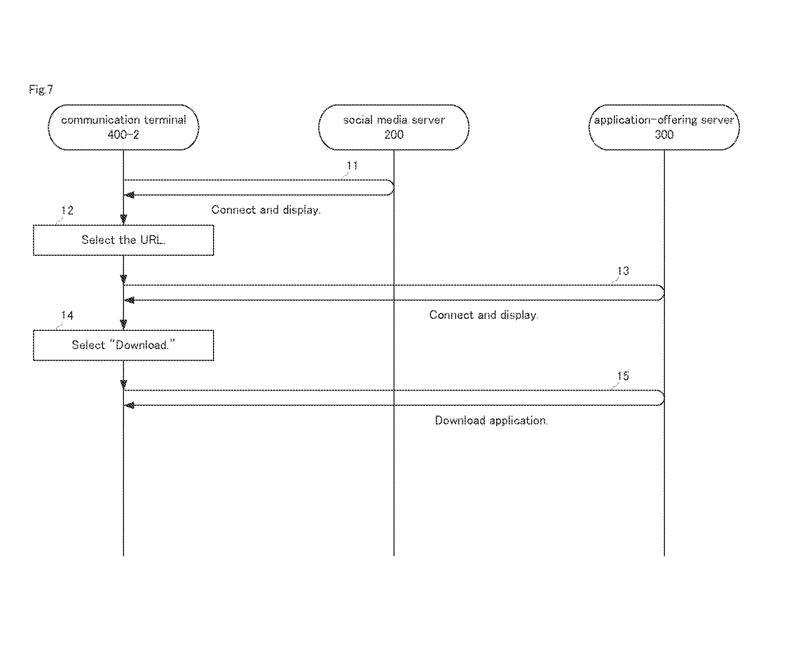

The process by which communication terminal 400-2 downloads application “AAA” based on the information disclosed by communication terminal 400-1 is next described with reference to FIG. 7. In the following explanation, a case is taken as an example in which the user of communication terminal 400-1 discloses the invitation code and the URL for acquiring application “AAA” on his or her own blog that is provided by social media server 200.

In Step 11, communication terminal 400-2 first connects to social media server 200 based on the operation of the user of communication terminal 400-2 and displays the blog of the user of communication terminal 400-1. The invitation code and the URL for acquiring (downloading) application “AAA” are described in the displayed blog. The display of this URL, similar to typically used URLs, extends a link, and when the URL is selected by, for example, clicking, a connection may be made to application-offering server 300 that is the site at which application “AAA” can be acquired.

When the displayed URL is selected by the operation of the user of communication terminal 400-2 in Step 12, communication terminal 400-2 then connects to application-offering server 300 in Step 13 and displays a page that offers application “AAA.” This offer page displays a button for acquiring (downloading) application “AAA.”

When the displayed button for downloading is selected in Step 14 by the operation of the user of communication terminal 400-2, application-offering server 300 carries out a process of authenticating communication terminal 400-2 and a process of charging communication terminal 400-2. In Step 15, application “AAA” is downloaded to communication terminal 400-2 from application-offering server 300. Communication terminal 400-2 installs application “AAA” that was downloaded.

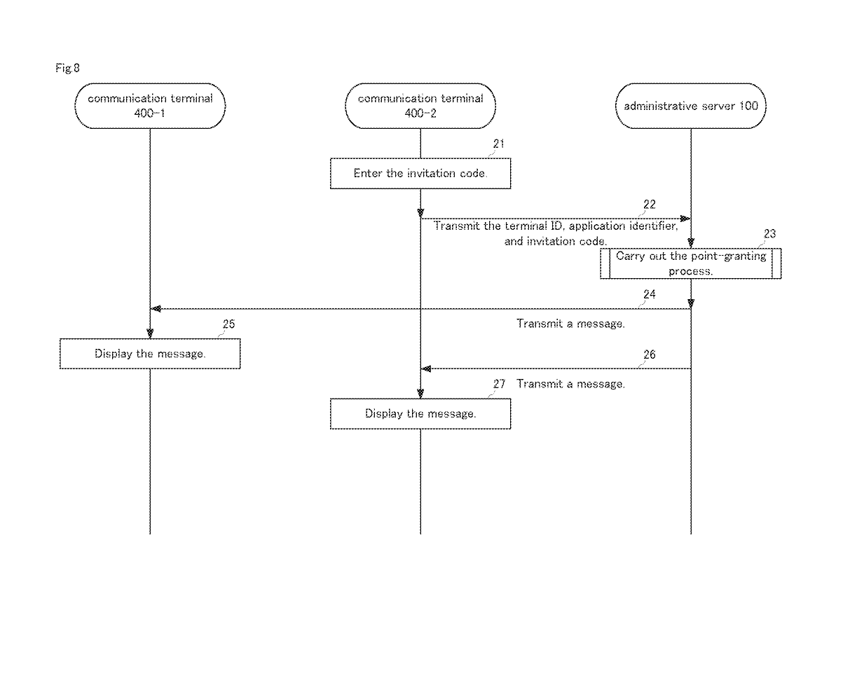

The process of granting a benefit is next described with reference to FIG. 8 for a case in which communication terminal 400-2 executes application “AAA” and the input of the invitation code that was disclosed by another person is accepted on application “AAA.”

Communication terminal 400-2 executes application “AAA” that was installed, and when the operation by the user for entering the invitation code is accepted, a display is implemented for entering the invitation code. The operation for entering the invitation code is an operation such as the user who selects (clicking) the display of “use invitation code” that is displayed on application “AAA.” When the invitation code is entered in accordance with this display in Step 21, communication terminal 400-2 transmits an invitation code use signal that includes the terminal ID of communication terminal 400-2 (in this case “T001”), the application identifier “AAA” of application “AAA,” and the invitation code to administrative server 100. The invitation code that is entered in this case is “S000” that was described in the blog of the user of communication terminal 400-1 and that was used for the downloading of application “AAA” by communication terminal 400-2.

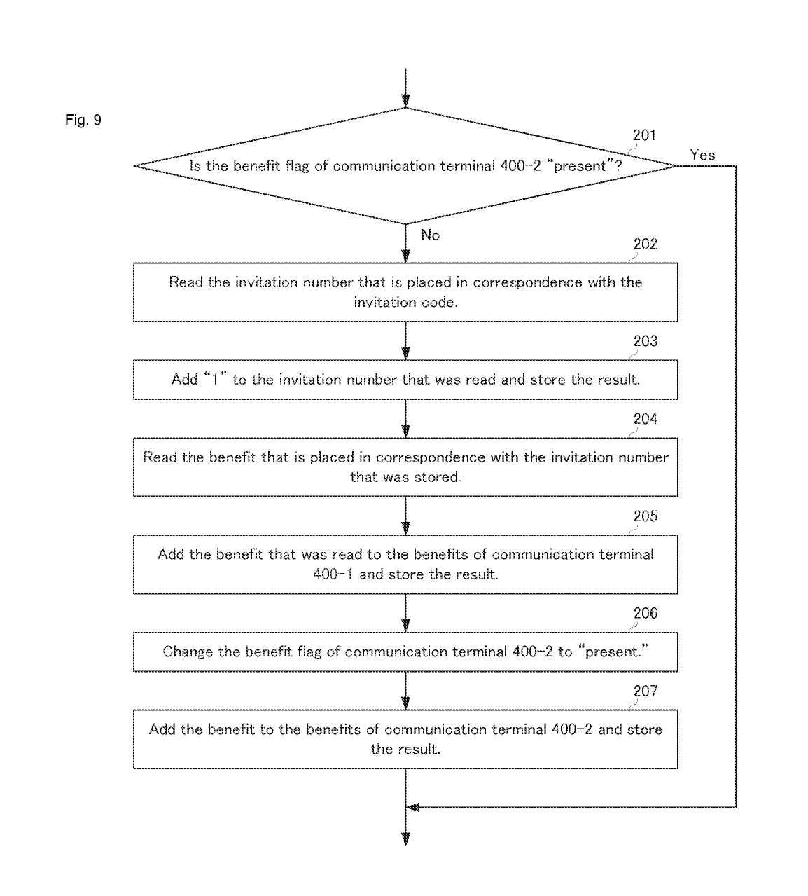

Administrative server 100 then carries out the process of granting points in Step 23. An example of the details of the point-granting process of Step 23 is next described with reference to FIG. 9.

When an invitation code use signal that contains terminal ID “T001,” application identifier “AAA,” and invitation code “S000” is transmitted from communication terminal 400-2, benefit granting unit 104 judges whether the benefit flag of application identifier “AAA” that is placed in correspondence with terminal ID “T0001” of the invitation code table that is stored in database 102 is “present” (or “invalid”) in Step 201.

If the benefit flag of application identifier “AAA” that is placed in correspondence with terminal ID “T001” is “present” (or “invalid”), a benefit is not granted.

On the other hand, if the benefit flag of application identifier “AAA” that is placed in correspondence with terminal ID “T001” is not “present” (or “invalid”), benefit granting unit 104 reads the invitation number that is placed in correspondence with invitation code “S000” of the invitation code table that is stored in database 102 in Step 202. In Step 203, benefit granting unit 104 adds “1” to the invitation number that was read, and writes and stores the invitation number that is placed in correspondence with invitation code “S000” of the invitation code table that is stored in database 102. In other words, benefit granting unit 104 increments by “1” the invitation number that is placed in correspondence with invitation code “S000” of the invitation code table that is stored in database 102. For example, if the invitation number of terminal ID “T000” that is placed in correspondence with invitation code “S000” of the invitation code table that is stored in database 102 is “0,” benefit granting unit 104 writes “1” in the invitation number.

Benefit granting unit 104 next reads the benefit that is placed in correspondence with the invitation number that was written in Step 203, i.e., the invitation number after incrementing, from the grade table of database 102 in Step 204. When the correspondences such as shown in FIG. 4 are stored in the grade table, the benefit “1 point” is read when the invitation number is “1.” Benefit granting unit 104 next, in Step 205, adds the benefit “1 point” that was read to the point number that is placed in correspondence with invitation code “S000” of the invitation code table. For example, when the point number of terminal ID “T000” that is stored in correspondence with invitation code “S000” of the invitation code table is currently “0” and the benefit that was read from the grade table is “1 point,” benefit granting unit 104 adds these values and updates the point number of terminal ID “T000” that is stored in correspondence with invitation code “S000” of the invitation code table to “1.”

Next, in Step 206, benefit granting unit 104 changes the benefit flag of application identifier “AAA” that is placed in correspondence with terminal ID “T001” of the invitation code table to “present.” In Step 207, benefit-granting unit 104 further grants the predetermined benefit for invitation code use (for example, 2 points) to communication terminal 400-2. More specifically, benefit granting unit 104 adds 2 points to the point number that is placed in correspondence with terminal ID “T001” and stores the result in the invitation code table.

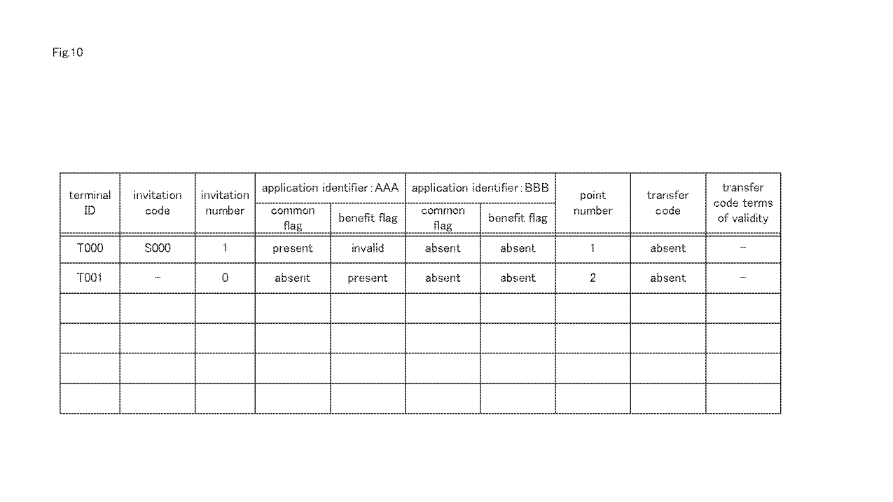

As shown in FIG. 10, the invitation number that is placed in correspondence with invitation code “S000” of the invitation code table that is stored in database 102 after the point-granting process of Step 23 is “1” (the process of Step 203) and the point number is “1” (the process of Step 205). In addition, the benefit flag of application identifier “AAA” that is placed in correspondence with terminal ID “T001” is “present” (the process of Step 206) and the point number is “2” (the process of Step 207).

After completion of the point-granting process, benefit-granting unit 104 in Step 24 transmits a message indicating that a benefit (points) has been granted to communication terminal 400-1 by way of communication unit 101. In Step 25, communication terminal 400-1 displays the message that was transmitted in from administrative server 100 on application “AAA.” This display need not be on application “AAA” and may also be shown on the display of communication terminal 400-1 as a typical notification.

In addition, in Step 26, benefit-granting unit 104 transmits by way of communication unit 101 a message indicating that a benefit (points) has been granted to communication terminal 400-2. In Step 27, communication terminal 400-2 displays the message that is transmitted in from administrative server 100 on application “AAA.” This display need not be shown on application “AAA” and may also be shown on the display of communication terminal 400-2 as a typical notification.

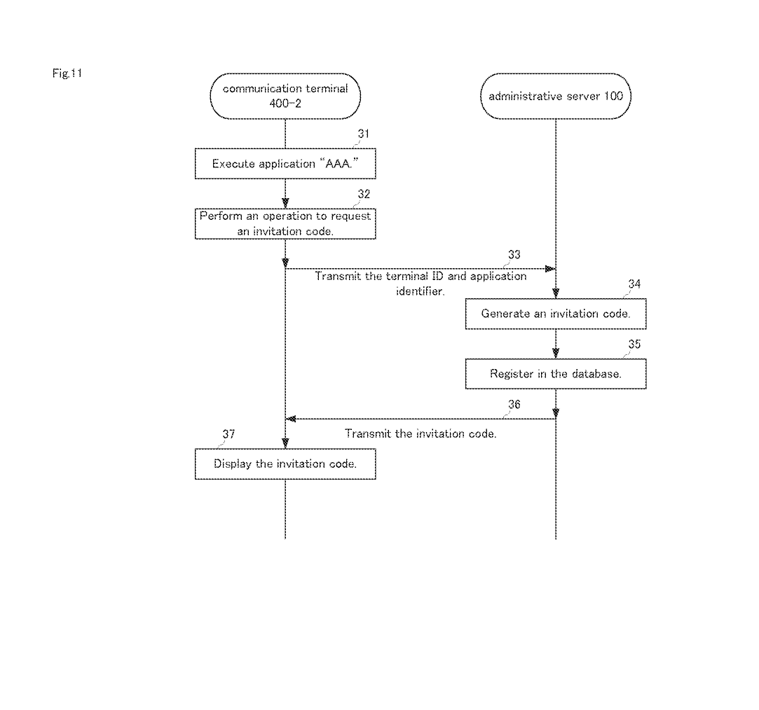

The processes for a case in which communication terminal 400-2 that has installed application “AAA” requests an invitation code are next described with reference to FIG. 11. An example is described for a case in which the correspondences shown in FIG. 10 are stored in the invitation code table.

In Step 31, communication terminal 400-2 executes application “AAA” that has been downloaded, and when the operation to request an invitation code is received in Step 32, communication terminal 400-2 transmits terminal ID “T001” and application identifier “AAA” to administrative server 100 in Step 33. As the operation for requesting the invitation code in this case, an operation is shown in which the user selects “issue invitation code” that is displayed on application “AAA.” When communication terminal 400-2 transmits terminal ID “T001” and application identifier “AAA,” this information is included in an invitation code request signal that indicates that an invitation code is being requested and transmitted.

When the invitation code request signal that contains terminal ID “T001” and application identifier “AAA” is transmitted in from communication terminal 400-2, code generation unit 103 of administrative server 100 checks whether the invitation code for terminal ID “T001” has been registered in the invitation code table (whether application identifier “AAA” is stored such that it can issue (generate) an invitation code, or, when application identifier “AAA” is stored, whether the common flag is “present” for application identifier “AAA” of terminal ID “T001”). In the case of the content of the invitation code table shown in FIG. 10, an invitation code has not been registered for terminal ID “T001,” and code generation unit 103 of administrative server 100 therefore generates an invitation code based on a predetermined rule in Step 34. Code generation unit 103 then stores the invitation code that was generated in the invitation code table in correspondence with terminal ID “T001.” In addition, code generation unit 103 raises the common flag (sets to “present”) of application identifier “AAA” that corresponds to terminal ID “T001.” If, linked with the common flag of application identifier “AAA,” the benefit flag of application identifier “AAA” that corresponds to terminal ID “T001” is “absent” at this time, code generation unit 103 may raise the flag (set to “invalid”) indicating that the benefit flag is invalid. In this case, a benefit flag is not raised due to the use of another person's invitation code, whereby the predetermined benefit that corresponds to invitation code usage is not granted. For example, in the case of the content of the invitation code table shown in FIG. 10, because the benefit flag of application identifier “AAA” that corresponds to terminal ID “T001” is “present,” code generation unit 103 does not carry out any process in this case. In this way, code generation unit 103 registers information relating to terminal ID “T001” in the invitation code table of database 102 in Step 35.

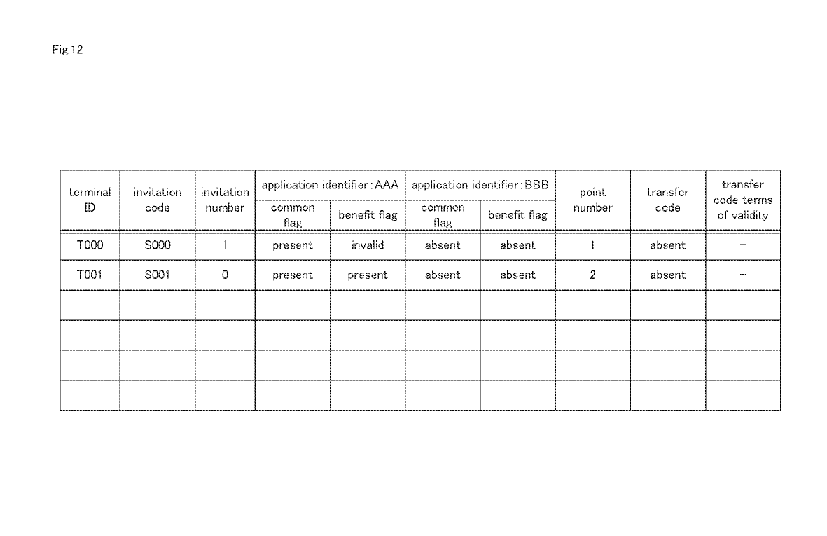

FIG. 12 shows an example of the invitation code table of database 102 in which information was registered in Step 35. An example is here shown in which the invitation code generated by code generation unit 103 in Step 34 is “S001.”

As shown in FIG. 12, when the process of Step 35 is carried out, the generated invitation code “S001” and the common flag “present” of application identifier: AAA are registered in the invitation code table corresponding to terminal ID “T001.”

Code generation unit 103 next transmits the generated invitation code to communication terminal 400-2 by way of communication unit 101 in Step 36, whereupon communication terminal 400-2 displays the invitation code that was transmitted in from administrative server 100 on application “AAA” in Step 37. This display need not be shown on application “AAA” but may be shown on the display of communication terminal 400-2 as a typical notification. The user of communication terminal 400-2 displays information such as this invitation code and the URL for acquiring application “AAA” on, for example, his or her own blog and thus promotes the use of application “AAA” to other users.

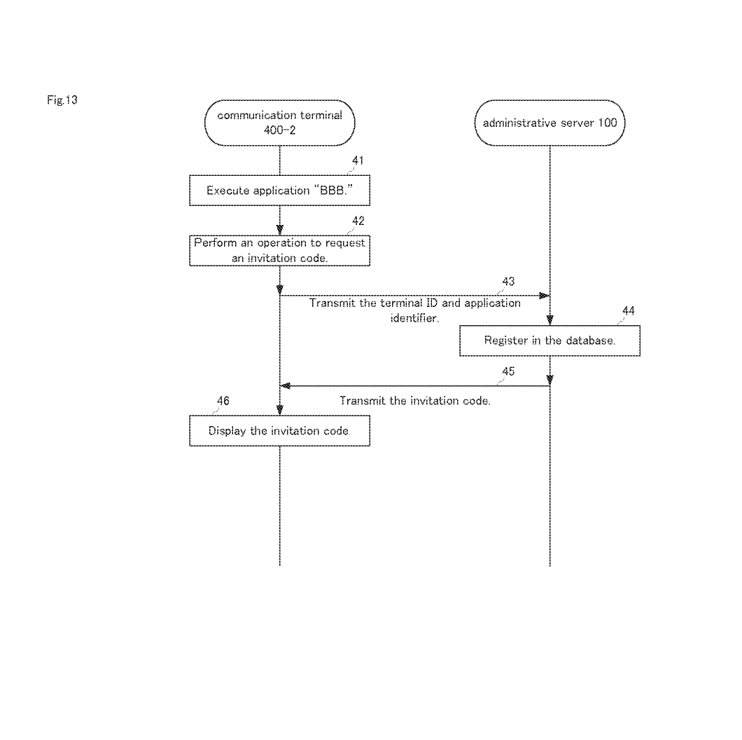

A case is next described with reference to FIG. 13 in which communication terminal 400-2 that has further also installed application “BBB” requests an invitation code. An example is here described by way of reference in which the correspondences shown in FIG. 12 have already been stored in the invitation code table. An example is here described in which application “BBB” has further also been installed in communication terminal 400-2 and, due to “invitation code usage” of the invitation code that was disclosed by another person, the benefit flag of application identifier “BBB” that is placed in correspondence with terminal ID “T001” has been changed from “absent” to “present,” “2” has been added to the point number, and the point number has become “4.”

In Step 41, communication terminal 400-2 executes application “BBB” that has been downloaded, and when the operation that requests an invitation code is accepted in Step 42, communication terminal 400-2 transmits terminal ID “T001” and application identifier “BBB” to administrative server 100 in Step 43. As the operation for requesting an invitation code, an operation is here described by way of example in which the user selects “issue invitation code” that is displayed in application “BBB.” When communication terminal 400-2 transmits terminal ID “T001” and application identifier “BBB,” this information is included and transmitted in an invitation code request signal that indicates that an invitation code is being requested.

When the invitation code request signal that includes terminal ID “T001” and application identifier “BBB” is transmitted in from communication terminal 400-2, code generation unit 103 of administrative server 100 verifies whether an invitation code has been registered for terminal ID “T001” in the invitation code table (whether application identifier “BBB” is stored such that it can issue (generate) an invitation code, or, when application identifier “BBB” is stored, whether the common flag for application identifier “BBB” of terminal ID “T001” is “present”). This time, the invitation code for terminal ID “T001” has already been registered, and code generation unit 103 of administrative server 100 therefore does not newly create an invitation code. Code generation unit 103 then raises the common flag of application identifier “BBB” that corresponds to terminal ID “T001” (sets to “present”). If, linked with the common flag of application identifier “BBB,” the benefit flag of application identifier “BBB” that corresponds to terminal ID “T001” is “absent” at this time, code generation unit 103 may raise a flag indicating that the benefit flag is invalid (set to “invalid”). In this case, the benefit flag of application identifier “BBB” that corresponds to terminal ID “T001” is “present,” whereby code generation unit 103 does not carry out any process. Code generation unit 103 thus registers information relating to terminal ID “T001” in the invitation code table of database 102 in Step 44.

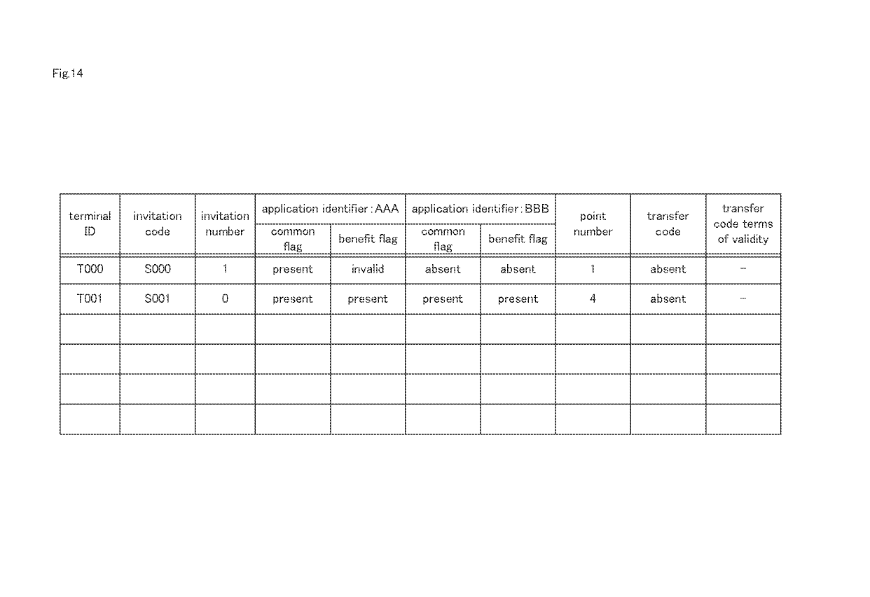

As shown in FIG. 14, when the process of Step 44 is carried out, the common flag “present” of application identifier BBB is registered in the invitation code table of database 102 in correspondence with terminal ID “T001.”

Code generation unit 103 next transmits the invitation code “S001” that was placed in correspondence with terminal ID “T001” to communication terminal 400-2 by way of communication unit 101 in Step 45, whereupon communication terminal 400-2 displays the invitation code that was transmitted in from administrative server 100 on application “BBB” in Step 46. This display need not be shown on application “BBB” but may be shown on the display of communication terminal 400-2 as a typical notification. The user of communication terminal 400-2 discloses information such as this invitation code and the URL for acquiring application “BBB” on, for example, his or her own blog and thus promotes the use of application “BBB” to other users.

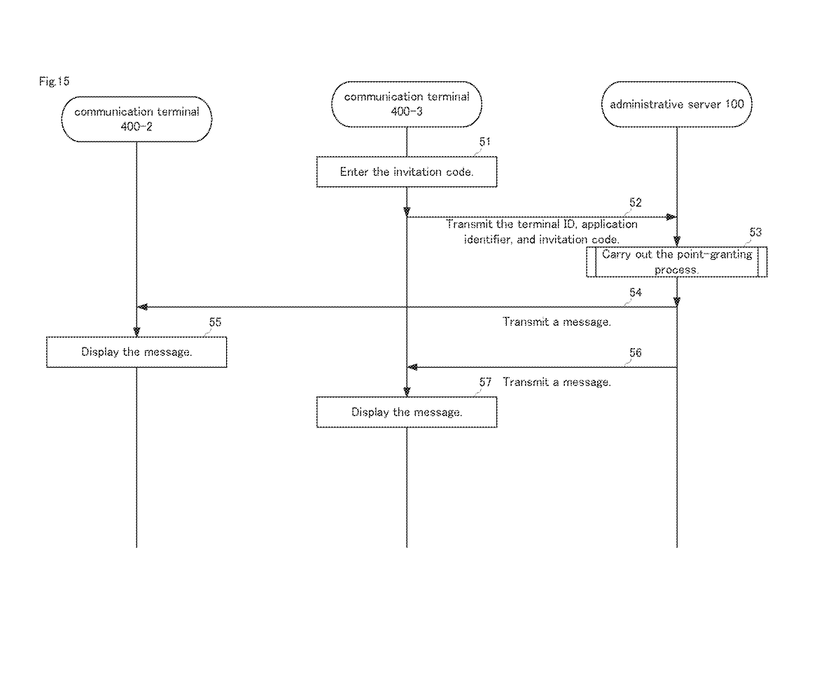

The process of granting a benefit when communication terminal 400-3 executes application “AAA” and input of the invitation code is received on application “AAA” is next described with reference to FIG. 15. A case is here described by way of example in which the invitation code that is applied as input is “S001” that was described in the blog of the user of communication terminal 400-2 and that was used in the downloading of application “AAA” by communication terminal 400-3. In addition, a case is here described in which the content shown in FIG. 14 is stored in the invitation code table of database 102, and further, in which the invitation number placed in correspondence with terminal ID “T001” is “3” and the point number is “7.”

Communication terminal 400-3 executes application “AAA” that was installed, and upon accepting the operation for the input of the invitation code by the user, implements display for the input of the invitation code. The operation for the input of this invitation code is an operation in which, for example, the user selects (clicks on) the display of, for example, “use invitation code.” When the invitation code “S001” is applied as input in accordance with this display in Step 51, communication terminal 400-3 transmits to administrative server 100 an invitation code use signal that includes the terminal ID of communication terminal 400-3 (in this case, “T005”), the application identifier “AAA” of application “AAA,” and the invitation code “S001” in Step 52.

With this transmission, administrative server 100 carries out the point-granting process in Step 53.

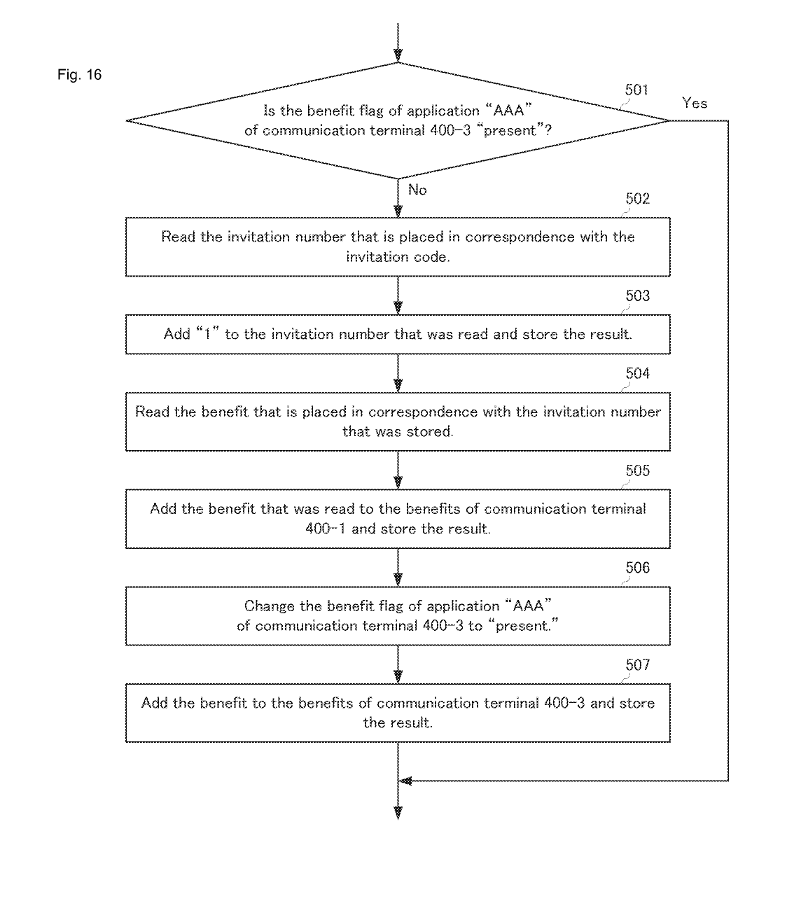

An example of the detailed process of the point-granting process of Step 53 is next described with reference to FIG. 16.

When the invitation code use signal that contains terminal ID “T005,” application identifier “AAA,” and invitation code “S001” is transmitted in from communication terminal 400-3, benefit granting unit 104 in Step 501 judges whether the benefit flag of application identifier “AAA” that is placed in correspondence with terminal ID “T005” is “present” in the invitation code table that is stored in database 102.

If the benefit flag of application identifier “AAA” that is placed in correspondence with terminal ID “T005” is “present,” a benefit is not granted.

On the other hand, when the benefit flag of the application identifier “AAA” that is placed in correspondence with terminal ID “T005” is not “present,” benefit granting unit 104 in Step 502 reads the invitation number that is placed in correspondence with invitation code “S001” of the invitation code table that is stored in database 102. In Step 503, benefit granting unit 104 adds “1” to the invitation number that was read and writes and stores the result in the invitation number that is placed in correspondence with invitation code “S001” of the invitation code table that is stored in database 102. In other words, benefit granting unit 104 increments by “1” the invitation number that is placed in correspondence with invitation code “S001” of the invitation code table that is stored in database 102. For example, when the invitation number of terminal ID “T001” that is placed in correspondence with invitation code “S001” of the invitation code table that is stored in database 102 is “3,” benefit granting unit 104 writes “4” in the invitation number.

Benefit granting unit 104 next, in Step 504, reads from the grade table of database 102 the benefit that is placed in correspondence with the invitation number that was written in Step 503, i.e., the invitation number that follows incrementing. When correspondences such as shown in FIG. 4 are stored in the grade table, the benefit “1 point” is read when the invitation number is “4.” Benefit granting unit 104 then, in Step 505, adds the benefit “1 point” that was read to the point number that is stored in the invitation code table. For example, if the point number that is currently stored in the invitation code table is “7” and the benefit that is read from the grade table is “1 point,” benefit granting unit 104 adds these values to update the point number that is stored in the invitation code table to “8.”

In addition, in Step 506, benefit granting unit 104 makes the benefit flag of the application identifier “AAA” that is placed in correspondence with terminal ID “T005” of the invitation code table “present.” Benefit granting unit 104 further grants to communication terminal 400-3 the predetermined benefit for invitation code usage (for example, 2 points) in Step 507. More specifically, benefit granting unit 104 adds 2 points to the point number that is placed in correspondence with terminal ID “T005” and stores the result in the invitation code table.

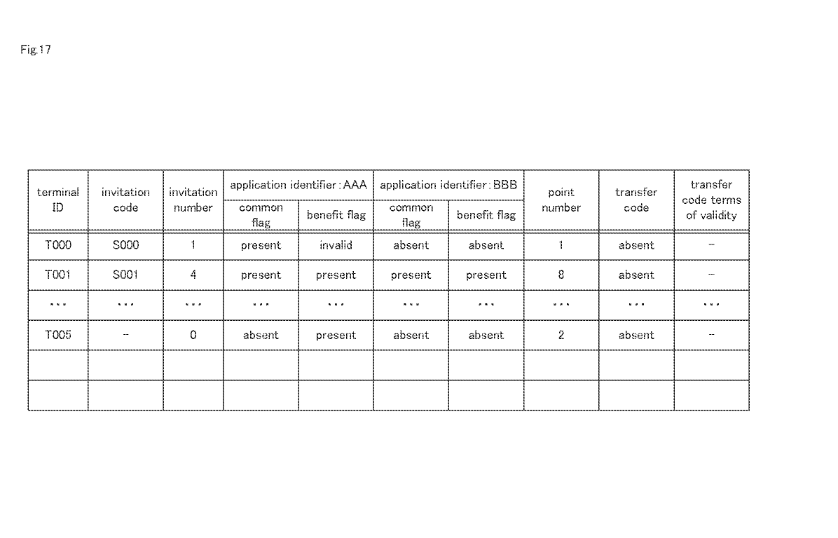

As shown in FIG. 17, after the point-granting process of Step 53 is completed, the invitation number that is placed in correspondence with invitation code “S001” of the invitation code table that is stored in database 102 is “4” (the process of Step 503), and the point number is “8” (the process of Step 505). In addition, the benefit flag of application identifier “AAA” that is placed in correspondence with terminal ID “T005” is “present” (the process of Step 506), and the point number is “2” (the process of Step 507).

After the completion of the point-granting process, benefit-granting unit 104 in Step 54 transmits a message by way of communication unit 101 indicating that a benefit (points) has been granted to communication terminal 400-2. In Step 55, communication terminal 400-2 displays the message that was transmitted in from administrative server 100 on application “AAA.” This display need not be shown on application “AAA” and may be shown on the display of communication terminal 400-2 as a typical notification.

In addition, benefit granting unit 104 further, in Step 56, transmits a message to communication terminal 400-3 by way of communication unit 101 indicating that a benefit (points) was granted. In Step 57, communication terminal 400-3 displays on application “AAA” the message that was transmitted in from administrative server 100. This display need not be shown on application “AAA” and may be shown on the display of communication terminal 400-3 as a typical notification.

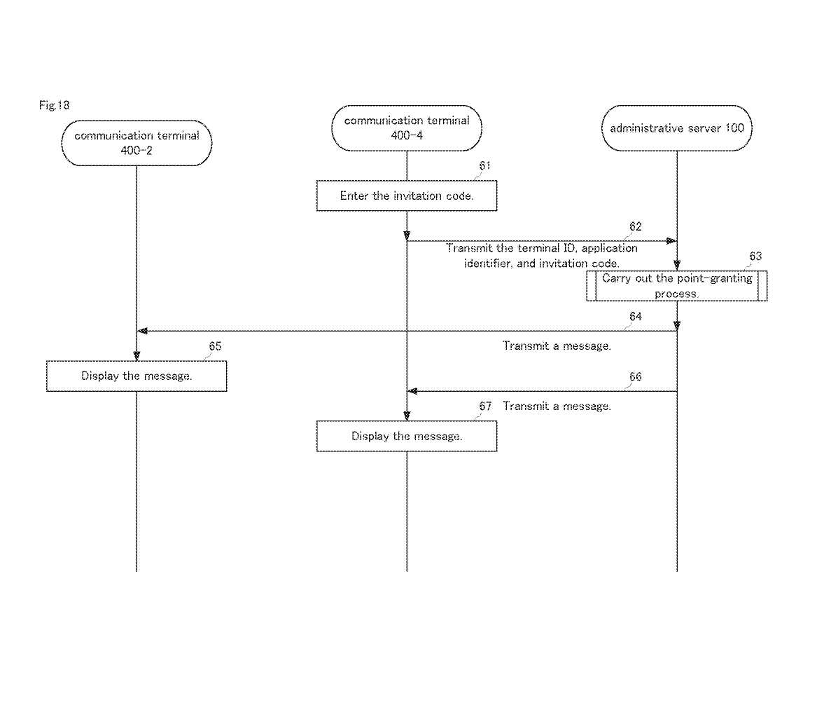

The process of granting a benefit when communication terminal 400-4 executes application “BBB” and the input of an invitation code on application “BBB” is received is next described with reference to FIG. 18. A case is here described by way of example in which the invitation code that is received as input is “S001” that was described in the blog of the user of communication terminal 400-2 and was used for communication terminal 400-4 to download application “BBB.” In addition, a case is described by way of example in which the content shown in FIG. 17 is stored in the invitation code table of database 102.

Communication terminal 400-4 executes application “BBB” that was installed and upon accepting the operation for the input of an invitation code by the user, carries out display for the input of the invitation code. The operation for the input of this invitation code is, for example, an operation in which the user clicks on the display of “use invitation code.” When the invitation code “S001” is applied as input in Step 61 in accordance with this display, communication terminal 400-4 in Step 62 transmits an invitation code use signal to administrative server 100 that contains the terminal ID of communication terminal 400-4 (in this case, “T006”), the application identifier “BBB” of application “BBB,” and invitation code “S001.”

With this transmission, administrative server 100 carries out the point-granting process in Step 63.

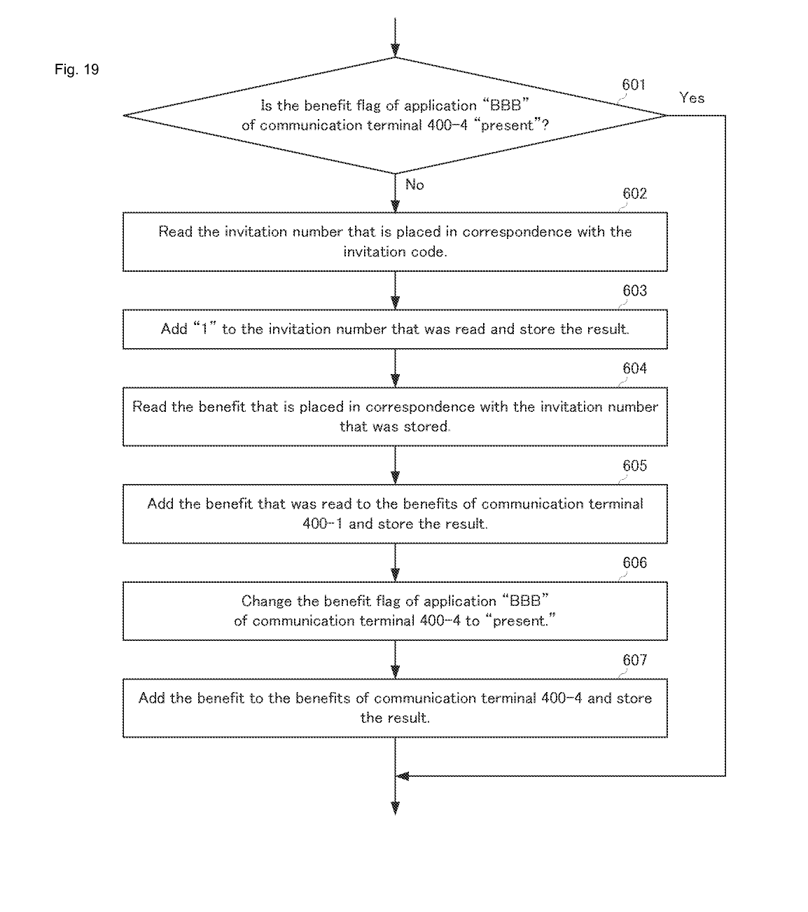

An example of the details of the point-granting process of Step 63 is next described with reference to FIG. 19.

When the invitation code use signal that contains the terminal ID “T006,” application identifier “BBB,” and invitation code “S001” is transmitted in from communication terminal 400-4, benefit granting unit 104 in Step 601 judges whether the benefit flag of application identifier “BBB” that is placed in correspondence with terminal ID “T006” is “present” in the invitation code table that is stored in database 102.

If the benefit flag of application identifier “BBB” that is placed in correspondence with terminal ID “T006” is “present,” a benefit is not granted.

On the other hand, if the benefit flag of application identifier “BBB” that is placed in correspondence with terminal ID “T006” is not “present,” benefit granting unit 104 in Step 602 reads the invitation number that is placed in correspondence with invitation code “S001” of the invitation code table that is stored in database 102. In Step 603, benefit granting unit 104 adds “1” to the invitation number that was read and then writes and stores the result in the invitation number that is placed in correspondence with invitation code “S001” of the invitation code table that is stored in database 102. In other words, benefit granting unit 104 increments by “1” the invitation number that is placed in correspondence with invitation code “S001” of the invitation code table that is stored in database 102. For example, if the invitation number of terminal ID “T001” that is placed in correspondence with invitation code “S001” of the invitation code table that is stored in database 102 is “4,” benefit granting unit 104 writes “5” in the invitation number.

Benefit granting unit 104 next, in Step 604, reads from the grade table of database 102 the benefit that is placed in correspondence with the invitation number that was written in Step 603, i.e., the invitation number that follows incrementing. If the correspondences such as shown in FIG. 4 are stored in the grade table, the benefit “3 points” will be read if the invitation number is “5.” In Step 605, benefit granting unit 104 next adds the benefit “3 points” that was read to the point number that is stored in the invitation code table. For example, if the point number that is currently stored in the invitation code table is “8” and if the benefit that was read from the grade table is “3 points,” benefit granting unit 104 adds these values and updates the point number that is stored in the invitation code table to “11.”

In Step 606, benefit granting unit 104 further makes the benefit flag of application identifier “BBB” that is placed in correspondence with terminal ID “T006” of the invitation code table “present.” In Step 607, benefit-granting unit 104 further grants to communication terminal 400-4 the predetermined benefit for use of the invitation code (for example, 2 points). More specifically, benefit granting unit 104 adds 2 points to the point number that was placed in correspondence with terminal ID “T006” and stores the result in the invitation code table.

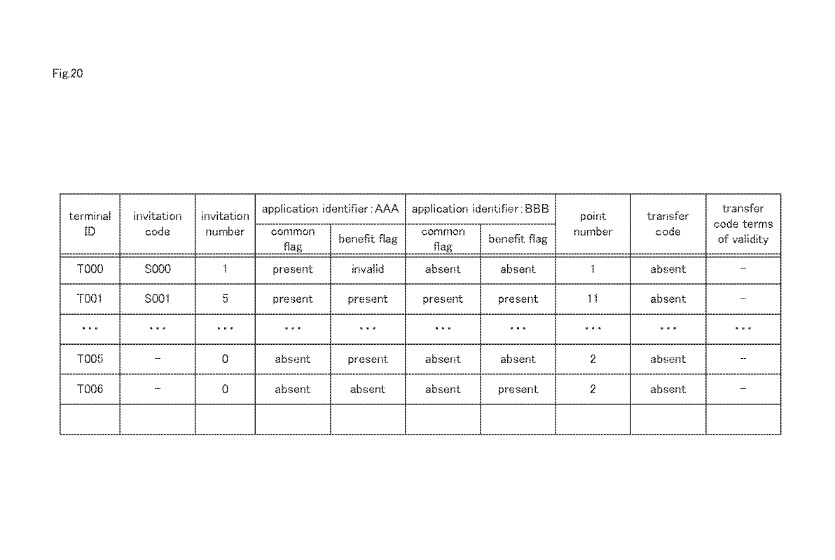

As shown in FIG. 20, after the point-granting process of Step 63 is completed, the invitation number that is placed in correspondence with invitation code “S001” of the invitation code table that is stored in database 102 is “5” (the process of Step 603) and the point number is “11” (the process of Step 605). In addition, the benefit flag of application identifier “BBB” that is placed in correspondence with terminal ID “T006” is “present” (the process of Step 606), and the point number is “2” (the process of Step 607).

After the point-granting process has been completed, benefit-granting unit 104 in Step 64 transmits a message to communication terminal 400-2 by way of communication unit 101 indicating that a benefit (points) has been granted. In Step 65, communication terminal 400-2 displays the message that has been transmitted in from administrative server 100 on application “BBB.” This display need not be displayed on application “BBB” but may also be shown on the display of communication terminal 400-2 as a typical notification.

Benefit granting unit 104 further transmits a message by way of communication unit 101 indicating that a benefit (points) has been granted to communication terminal 400-4 in Step 66. In Step 67, communication terminal 400-4 displays the message that was transmitted in from administrative server 100 on application “BBB.” This display need not be shown on application “BBB” but may also be shown on the display of communication terminal 400-4 as a typical notification.

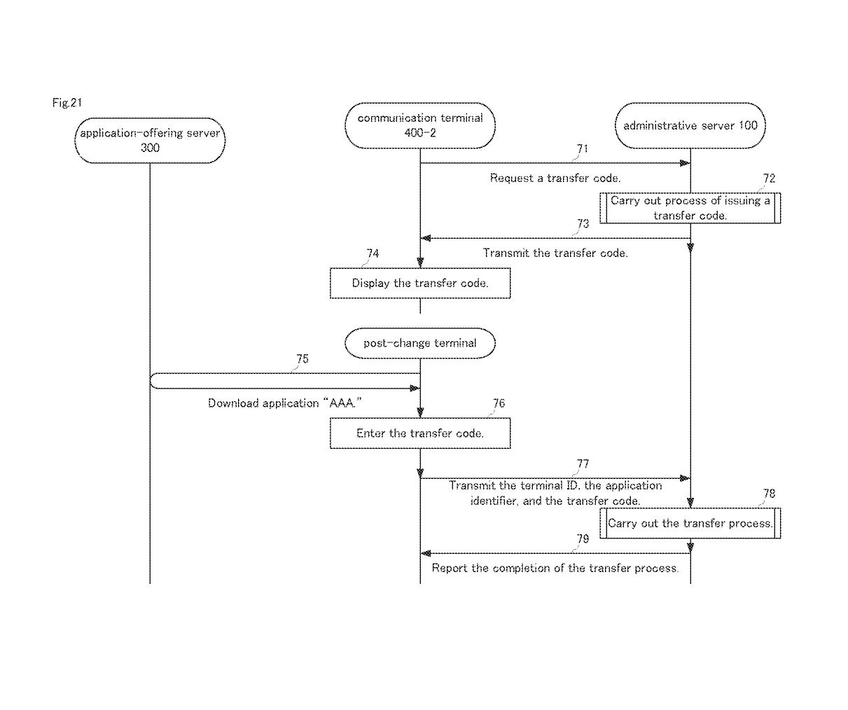

The process of the transfer of benefits for a case in which a user changes the type of communication terminal that is registered in the invitation code table is next described with reference to FIG. 21. A case is here described as an example of the process of transferring benefits when changing from communication terminal 400-2 to a new communication terminal (hereinbelow referred to as the “post-change terminal”). In addition, a case is described as an example in which the information regarding communication terminal 400-2 is registered as shown in FIG. 20.

Communication terminal 400-2 first executes application “AAA” that has been downloaded, and upon accepting the operation for requesting a transfer code for transferring benefits that were granted to communication terminal 400-2, communication terminal 400-2 in Step 71 transmits to administrative server 100 a transfer code request signal indicating that a transfer code has been requested and that contains terminal ID “T001.” As the operation for requesting the transfer code, a case is here described in which the user selects “issue transfer code” that is displayed on application “AAA.”

With this transmission, administrative server 100 in Step 72 carries out a transfer code issuing process.

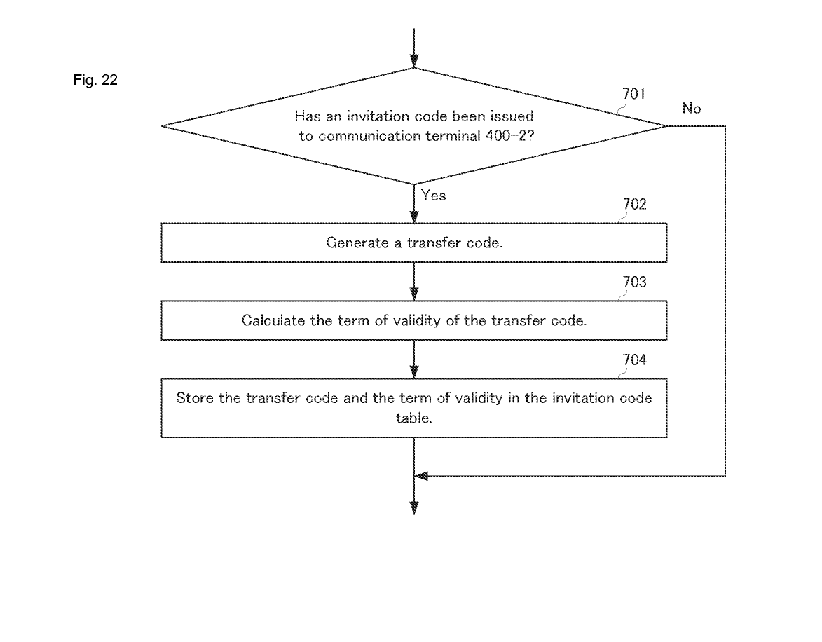

An example of the details of the process of Step 72 of issuing a transfer code is next described with reference to FIG. 22.

When the transfer code request signal is transmitted in from communication terminal 400-2, transfer processing unit 105 in Step 701 judges whether an invitation code has been generated for terminal ID “T001” that is contained in the transfer code request signal. More specifically, transfer processing unit 105 judges whether an invitation code has been stored in correspondence with terminal ID “T001” in the invitation code table of database 102.

If an invitation code has not been generated for terminal ID “T001” that is contained in the transfer code request signal, the transfer code issuing process is not carried out.

On the other hand, if an invitation code has been generated for terminal ID “T001” that is contained in the transfer code request signal, transfer processing unit 105 generates a transfer code in Step 702. Transfer processing unit 105 may use terminal ID “T001” to generate a transfer code based on a predetermined rule (a rule that uses hashing or other information), or may generate a transfer code at random.

In Step 703, transfer processing unit 105 further calculates the term of validity of the transfer code that was generated. No particular limitation is imposed on the method of calculation, and transfer processing unit 105 may calculate the time of passage of a predetermined interval (for example, one week) from the date and time of the generation of a transfer code as the term of validity, or may calculate the last day of the month in which the transfer code was generated as the term of validity.

In Step 704, transfer processing unit 105 next stores the generated transfer code and calculated transfer code term of validity in correspondence with terminal ID “T001” of the invitation code table.

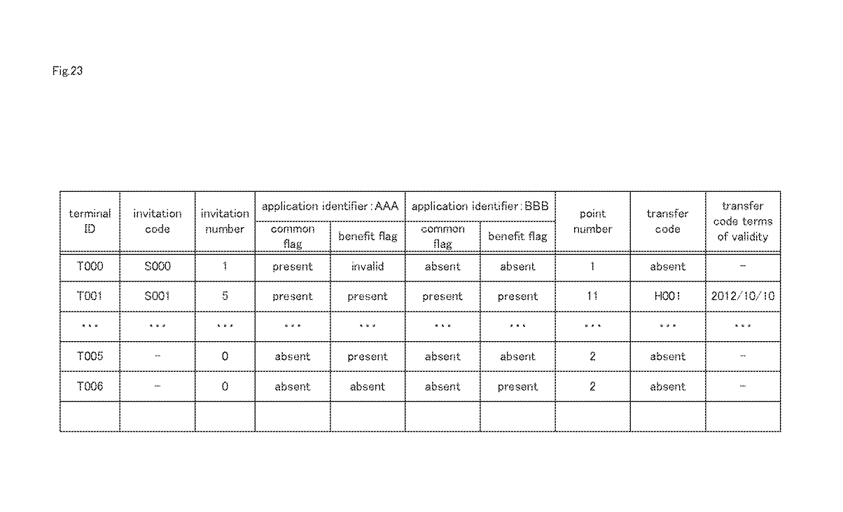

As shown in FIG. 23, after the transfer code issuing process of Step 72, the transfer code that is placed in correspondence with terminal ID “T001” of the invitation code table that is stored in database 102 is “H001” and the transfer code term of validity is “2012/10/10.”

In Step 73, transfer processing unit 105 transmits the generated transfer code “H001” to communication terminal 400-2 by way of communication unit 101, whereupon, communication terminal 400-2 displays the transfer code “H001” that was transmitted in from administrative server 100 on application “AAA” in Step 74. This display need not be on application “AAA” but may also be shown on the display of communication terminal 400-2 as a typical notification. In addition, transfer processing unit 105 may also transmit the transfer code term of validity together with the transfer code, and communication terminal 400-2 may also display these items.

The user of communication terminal 400-2 then changes the type of apparatus to the post-change terminal, and in Step 75, application “AAA” is downloaded to the post-change terminal, the post-change terminal executes application “AAA” that was downloaded, and upon accepting an operation by the user for applying the transfer code as input, carries out display for the input of the transfer code. The operation for the input of the transfer code is, for example, an operation such as the user selecting (clicking on) a display such as “transfer invitation code.” When the transfer code is applied as input in accordance with this display, the post-change terminal in Step 77 transmits to administrative server 100 an invitation code transfer signal that contains the terminal ID “T011” of the post-change terminal, the application identifier “AAA” of application “AAA,” and the transfer code “H001” to request transfer.

When this transmission is completed, transfer processing unit 105 carries out the transfer process in Step 78.

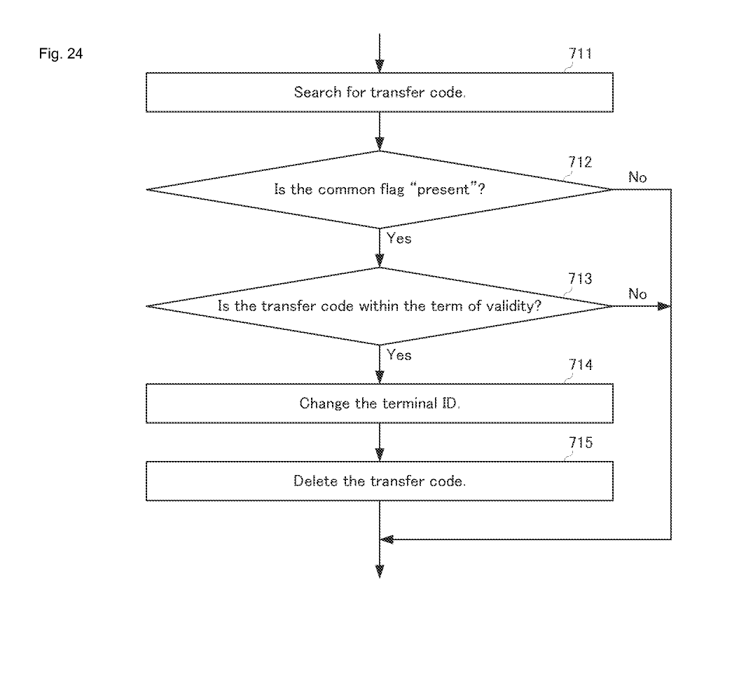

An example of the details of the process of the transfer code issuing process of Step 78 is next described with reference to FIG. 24.

When the invitation code transfer signal that contains terminal ID “T011,” application identifier “AAA,” and transfer code “H001” is transmitted in from the post-change terminal, transfer processing unit 105 in Step 711 searches the invitation code table of database 102 for transfer code “H001” that was transmitted. Transfer processing unit 105 further, in Step 712, judges whether the common flag of application identifier “AAA” that was placed in correspondence with transfer code “H001” that was transmitted in is “present” in the invitation code table of database 102.

If the common flag of application identifier “AAA” that is placed in correspondence with transfer code “H001” is “present” in the invitation code table of database 102, transfer processing unit 105 in Step 713 judges whether transfer code “H001” is within the transfer code term of validity that is placed in correspondence with transfer code “H001.”

If transfer code “H001” is not within the transfer code term of validity that is placed in correspondence with transfer code “H001,” the transfer process is not carried out.

However, if transfer code “H001” is within the transfer code term of validity that is placed in correspondence with transfer code “H001,” transfer processing unit 105 in Step 714 changes the terminal ID that was placed in correspondence with transfer code “H001” in the invitation code table of database 102 to the terminal ID “T011” that was transmitted in from the post-change terminal. Then, in Step 715, transfer processing unit 105 deletes transfer code “H001” and the transfer code term of validity from the invitation code table.

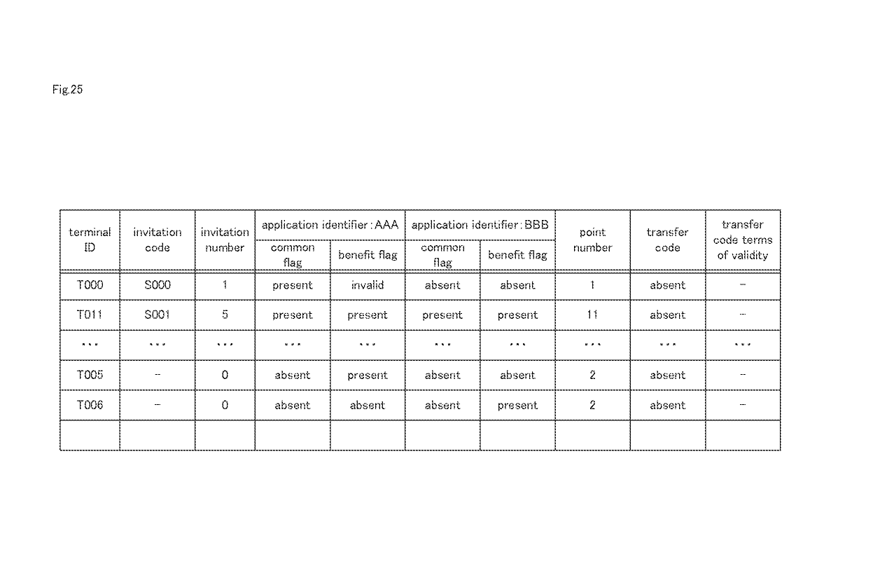

As shown in FIG. 25, after the transfer process of Step 78 is completed, the terminal ID that is placed in correspondence with the point number and invitation code that had been placed in correspondence with terminal ID “T001” of the invitation code table that is stored in database 102 becomes “T011”, and the transfer code and transfer code term of validity are deleted. The benefits that had been granted to communication terminal 400-2 (terminal ID “T001”) before the change of apparatus type are thus transferred to the post-change terminal (terminal ID “T011”) after the change of the apparatus type.

In Step 79, transfer processing unit 105 transmits to the post-change terminal a transfer process completion notification indicating that the transfer process has been completed.

In addition, the post-change terminal may also display the transfer process completion notification that was transmitted in from administrative server 100. At this time, the post-change terminal may display the transfer process completion notification on application “AAA” or may show the notification on the display of the post-change terminal as a typical notification. Alternatively, when the post-change terminal downloads application “BBB” and requests the transfer process, the processes are the same as for the case of application “AAA” with the exception that the process of Step 712 becomes a process in which the common flag of application identifier “BBB” is judged.

In this way, the rate of increase of benefits obtained by a user increases in accordance with the increase in the number of other users that apply the invitation code as input that was disclosed by the user. Further, an acquired invitation code can be used to introduce other applications of the application business, and if the rate of increase of benefits is raised by the use of the application that was used in the generation of the invitation code, higher benefits can be obtained based on this raised rate of increase for other applications that are newly introduced. As a result, the motivation to introduce applications of the application business to other users can be maintained. In addition, the introduction of new applications of the business is facilitated.

The processes that are carried out by each of the constituent elements provided in the above-described administrative server 100 may be performed by logical circuits that are each fabricated according to their purpose. Alternatively, a computer program that describes the processing content as procedures (hereinbelow referred to as a “program”) may be recorded on a recording medium that can be read in administrative server 100, and the processes may then be realized by causing this program that is recorded on the recording medium to be read and executed by administrative server 100. The recording medium that can be read by administrative server 100 refers to a relocatable recording medium such as a floppy (registered trademark) disk, a magneto-optical disk, a DVD, or a CD, or to memory such as ROM, RAM, or HDD that is incorporated in administrative server 100. The program that is recorded on this recording medium is read by a CPU (not shown) that is provided in administrative server 100, whereby processes similar to those described hereinabove are carried out under the control of the CPU. Here, the CPU operates as a computer that executes the program that is read from the recording medium on which the program is recorded.

All or a portion of the above-described exemplary embodiments can be described as in the following NOTES, but the present invention is not limited to these NOTES.

### NOTE 1:

An administrative system comprising a communication terminal and an administrative server; wherein:

the communication terminal uses an application to request that the administrative server provide an invitation code, and discloses an invitation code that is transmitted in response to the request, and also discloses application information for using the application;

the administrative server, when requested to provide the invitation code, generates an invitation code that is unique to the communication terminal and that can be used in common for a plurality of applications that are used in the invitation code request, transmits the invitation code that was generated to the communication terminal, and when another communication terminal uses the application to designate the invitation code that was disclosed, grants a benefit to the communication terminal that disclosed the invitation code according to an invitation number that is the number of communication terminals that designated the the invitation code.

### NOTE 2:

The administrative system as described in NOTE 1 that includes:

a database that stores: an invitation code table that places in correspondence terminal identification information that can identify the communication terminal, the invitation code, and the invitation number; and a grade table that places in correspondence the invitation numbers and the content of the benefits that accord with the invitation numbers;

wherein the administrative server, when the other communication terminal uses an application to designate the invitation code that was disclosed, reads from the grade table the content of the benefit that accords with the invitation number that is stored in correspondence with the invitation code in the invitation code table, and based on the content of the benefit that was read, grants the benefit to the communication terminal of the terminal identification information that is stored in correspondence with the invitation code in the invitation code table.

### NOTE 3:

The administrative system as described in NOTE 2, wherein the communication terminal transmits an invitation code request signal that contains the terminal identification information and an application identifier that can identify the application to request the invitation code; and

the administrative server, when having generated the invitation code, stores the terminal identification information that was transmitted in from the communication terminal, the invitation code that was generated, and the invitation number in mutual correspondence as the invitation code table in the database.

### NOTE 4:

The administrative system as described in NOTE 3, wherein the administrative server: when an invitation code use signal that contains terminal identification information of the other communication terminal, the application identifier, and the invitation code that was disclosed is transmitted in from the other communication terminal, judges that the other communication terminal used the application indicated by the application identifier to designate the invitation code; grants a predetermined benefit to the communication terminal of the terminal identification information that is contained in the invitation code use signal; and stores the terminal identification information that is contained in the invitation code use signal, and designation identification information that indicates that the invitation code has been designated for the application of the application identifier that is contained in the invitation code use signal in mutual correspondence as the invitation code table in the database.

### NOTE 5:

The administrative system as described in NOTE 4, wherein the administrative server, when the invitation code use signal is transmitted in, judges whether or not the designation identification information has already been placed in correspondence with the terminal identification information and the application identifier that is contained in the invitation code use signal in the invitation code table that is stored in the database, and if the designation identification information has already been placed in correspondence, the administrative server does not grand the benefit.

### NOTE 6:

The administrative system as described in NOTE 3, wherein the administrative server, when the invitation code request signal is transmitted in, judges the presence or absence of the invitation code that corresponds with the terminal identification information that is contained in the invitation code request signal in the invitation code table that is stored in the database, and if the invitation code is present, does not newly generate the invitation code but transmits the invitation code that corresponds to the terminal identification information, that is stored in the invitation code table, to the communication terminal that transmitted in the invitation code request signal.

### NOTE 7:

The administrative system as described in NOTE 6, wherein the administrative server: when generating the invitation code, also stores, in the invitation code table that is stored in the database, common identification information that indicates that the application of the application identifier that was transmitted in from the communication terminal has been used to request generation of the invitation code; when the invitation code request signal is transmitted in, judges whether or not the common identification information is present for the application identifier that is contained in the invitation code request signal in the invitation code table that is stored in the database; generates the invitation code if common identification information is not present for the application identifier that is contained in the invitation code request signal, and as well, the invitation code is not present; and does not newly generate the invitation code if the common identification information does not exist for the application identifier that is contained in the invitation code request signal, and as well, the invitation code is present.

### NOTE 8:

The administrative system as described in any one of NOTES 2 to 7, wherein the administrative server is equipped with the database.

### NOTE 9:

The administrative system as described in any one of NOTES 1 to 8, wherein the administrative server, when having granted the benefit, transmits a message to the communication terminal indicating that the benefit have been granted.

### NOTE 10:

The administrative system as described in any one of NOTES 1 to 9, wherein the administrative server: when notified from the communication terminal that the communication terminal is to change apparatus type, generates a transfer code for transferring benefits that have been granted to the communication terminal; transmits to the communication terminal the transfer code that was generated; and after change of apparatus type, when the transfer code is used to request transfer from the communication terminal, transfers the benefits, that had been granted to the communication terminal before the change of apparatus type, to the communication terminal after the change of apparatus type.

### NOTE 11:

The administrative system as described in any one of NOTES 1 to 10, wherein the application is an application that can be executed on a smartphone.

### NOTE 12:

An administrative server that includes:

a code generation unit that, when a request is made from a communication terminal to provide an invitation code, generates an invitation code that is unique to the communication terminal and that can be used in common for a plurality of applications that are used in the invitation code request, and transmits the generated invitation code to the communication terminal, and

a benefit granting unit that, when a communication terminal other than the communication terminal that is the transmission destination of the invitation code uses an application to designate the invitation code, grants to the communication terminal that is the transmission destination of the invitation code a benefit that accords with an invitation number that is the number of communication terminals that have designated the invitation code.

### NOTE 13:

An administration method that includes processes of:

when a communication terminal makes a request for an invitation code, generating an invitation code that is unique to the communication terminal and that can be used in common for a plurality of applications that are used in invitation code requests;

transmitting the invitation code that was generated to the communication terminal; and

when a communication terminal other than the communication terminal that is the transmission destination of the invitation code uses an application to designate the invitation code, granting to the communication terminal that is the transmission destination of the invitation code a benefit that accords with an invitation number that is the number of communication terminals that have designated the invitation code.

### NOTE 14:

A program for causing a computer to execute procedures of:

when an invitation code is requested from a communication terminal, generating an invitation code unique to the communication terminal that can be used in common for a plurality of applications used in the invitation code requests;

transmitting the invitation code that was generated to the communication terminal; and

when a communication terminal other than the communication terminal that is the transmission destination of the invitation code uses an application to designate the invitation code, granting a benefit that accords with the invitation number, which is the number of communication terminals that have designated the invitation code, to the communication terminal that is the transmission destination of the invitation code.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An administrative system comprising a communication terminal and an administrative server; wherein:
said communication terminal uses an application to request that said administrative server provide an invitation code, and discloses an invitation code that is transmitted in response to the request, and also discloses application information for using said application;
said administrative server, when requested to provide said invitation code, generates an invitation code that is unique to said communication terminal and that can be used in common for a plurality of applications that are used in the invitation code request, transmits the invitation code that was generated to said communication terminal, and when another communication terminal uses said application to designate said invitation code that was disclosed, grants a benefit to the communication terminal that disclosed the invitation code according to an invitation number that is the number of communication terminals that designated said the invitation code.

2. The administrative system as set forth in claim 1, further comprising:
a database that stores: an invitation code table that places in correspondence terminal identification information that can identify said communication terminal, said invitation code, and said invitation number; and a grade table that places in correspondence said invitation numbers and the content of said benefits that accord with the invitation numbers;
wherein said administrative server, when said other communication terminal uses an application to designate said invitation code that was disclosed, reads from said grade table the content of said benefit that accords with the invitation number that is stored in correspondence with the invitation code in said invitation code table, and based on the content of the benefit that was read, grants said benefit to said communication terminal of said terminal identification information that is stored in correspondence with the invitation code in said invitation code table.

3. The administrative system as set forth in claim 2, wherein:
said communication terminal transmits an invitation code request signal that contains said terminal identification information and an application identifier that can identify said application to request said invitation code; and
said administrative server, when having generated said invitation code, stores said terminal identification information that was transmitted in from said communication terminal, the invitation code that was generated, and said invitation number in mutual correspondence as said invitation code table in said database.

4. The administrative system as set forth in claim 3, wherein said administrative server: when an invitation code use signal that contains terminal identification information of said other communication terminal, said application identifier, and said invitation code that was disclosed is transmitted in from said other communication terminal, judges that said other communication terminal used the application indicated by the application identifier to designate the invitation code; grants a predetermined benefit to the communication terminal of the terminal identification information that is contained in said invitation code use signal; and stores said terminal identification information that is contained in said invitation code use signal, and designation identification information that indicates that the invitation code has been designated for the application of said application identifier that is contained in said invitation code use signal in mutual correspondence as said invitation code table in said database.

5. The administrative system as set forth in claim 4, wherein said administrative server, when said invitation code use signal is transmitted in, judges whether or not said designation identification information has already been placed in correspondence with said terminal identification information and said application identifier that is contained in said invitation code use signal in said invitation code table that is stored in said database, and if said designation identification information has already been placed in correspondence, said administrative server does not grand said benefit.

6. The administrative system as set forth in claim 3, wherein said administrative server, when said invitation code request signal is transmitted in, judges the presence or absence of said invitation code that corresponds with said terminal identification information that is contained in said invitation code request signal in said invitation code table that is stored in said database, and if said invitation code is present, does not newly generate said invitation code but transmits said invitation code that corresponds to said terminal identification information, that is stored in said invitation code table, to said communication terminal that transmitted in said invitation code request signal.

7. The administrative system as set forth in claim 6, wherein said administrative server: when generating said invitation code, also stores, in said invitation code table that is stored in said database, common identification information that indicates that the application of said application identifier that was transmitted in from said communication terminal has been used to request generation of said invitation code; when said invitation code request signal is transmitted in, judges whether or not said common identification information is present for the application identifier that is contained in said invitation code request signal in said invitation code table that is stored in said database; generates said invitation code if common identification information is not present for the application identifier that is contained in said invitation code request signal, and as well, said invitation code is not present; and does not newly generate said invitation code if the common identification information does not exist for the application identifier that is contained in said invitation code request signal, and as well, said invitation code is present.

8. The administrative system as set forth in claim 2, wherein said administrative server is equipped with said database.

9. The administrative system as set forth in claim 1, wherein said administrative server, when having granted said benefit, transmits a message to said communication terminal indicating that the benefit have been granted.

10. The administrative system as set forth in claim 1, wherein said administrative server: when notified from said communication terminal that the communication terminal is to change apparatus type, generates a transfer code for transferring benefits that have been granted to the communication terminal; transmits to the communication terminal said transfer code that was generated; and after change of apparatus type, when said transfer code is used to request transfer from the communication terminal, transfers the benefits, that had been granted to the communication terminal before said change of apparatus type, to said communication terminal after said change of apparatus type.

11. The administrative system as set forth in claim 1, wherein said application is an application that can be executed on a smartphone.

12. An administrative server comprising:
a code generation unit that, when a request is made from a communication terminal to provide an invitation code, generates an invitation code that is unique to said communication terminal and that can be used in common for a plurality of applications that are used in the invitation code request, and transmits the generated invitation code to said communication terminal, and
a benefit granting unit that, when a communication terminal other than the communication terminal that is the transmission destination of said invitation code uses an application to designate said invitation code, grants to the communication terminal that is the transmission destination of the invitation code a benefit that accords with an invitation number that is the number of communication terminals that have designated said invitation code.

13. An administration method comprising processes of:
when a communication terminal makes a request for an invitation code, generating an invitation code that is unique to said communication terminal and that can be used in common for a plurality of applications that are used in invitation code requests;
transmitting said invitation code that was generated to said communication terminal; and
when a communication terminal other than the communication terminal that is the transmission destination of said invitation code uses an application to designate said invitation code, granting to the communication terminal that is the transmission destination of the invitation code a benefit that accords with an invitation number that is the number of communication terminals that have designated said invitation code.
